(19) United States
(12) Patent Application Publication
(10) Pub. No.: US 2006/0195436 A1
(43) Pub. Date: Aug. 31, 2006

(54) Phased migration of database software application

(75) Inventors: Gilbert Levesque, Mountain View, CA (US); Murali Vinnakota, Sunnyvale, CA (US); Vidyadhar Joshi, Cupertino, CA (US)

Correspondence Address: BINGHAM MCCUTCHEN LLP, 3000 K STREET, NW, BOX IP, WASHINGTON, DC, 20007, US

(73) Assignee: Fujitsu Network Communications, Inc.

(21) Appl. No.: 11/067,270

(22) Filed: Feb. 28, 2005

(51) Int. Cl. G06F 17/30

(52) U.S. Cl. 707/4

(57) ABSTRACT

The present invention provides in-place, phased migration from one version of a database software application release version to another of a software release version. A method for phased migration of a database software application comprises developing a database software application in a plurality of phases of development, at least some of the plurality of phases of development requiring a change in a schema of a database used by the database software application; and for each of the phases of development that requires a change in a schema of the database, performing phase-wise migration of the database by sequentially modifying the schema of the database based on the changes in the schema of the database required by each phase.

### BACKGROUND OF THE INVENTION

1. Field of the Invention

The present invention relates to a computer program product to migrate a software system, that uses a database, without the loss of data nor the need to re-enter/re-create the data.

2. Description of the Related Art

The development of software applications is an expensive and time-consuming process. One feature of the software development cycle is the release of intermediate versions of the software before the final version of the software is released. Typically, such intermediate versions of software include only a portion of the functionality of the final version. Release of intermediate versions allows completed functionality to be tested before additional functionality is included in the software.

One common type of software application is a database application, which performs operations on data stored in a database. Currently, when an intermediate version of a database application is released, such as for testing, all the data in the database must be recreated in order to use the newly released intermediate version. This is a time-consuming and expensive step in the software development process.

A need arises for a technique that does not require all the data in a database to be recreated when intermediate versions of database application software are released.

### SUMMARY OF THE INVENTION

The present invention provides in-place, phased migration from one version of a database software application release version to another of a software release version. Using the present invention, a software release can be upgraded without recreating any associated database. The present invention provides improved migration performance, particularly when moderate schema changes occur in the new release. In addition, the present invention builds migration scripts while the new releases of the software application are being developed and provides migration from one development phase to another development phase in the same release. Phased migration provides improved system testing ability, particularly to test migrated platforms. Data migration issues are caught early in the development cycle, rather than at customer sites. Phased migration also reduces effort to re-install and recover the database for each development phase.

In one embodiment of the present invention, a method for phased migration of a database software application comprises developing a database software application in a plurality of phases of development, at least some of the plurality of phases of development requiring a change in a schema of a database used by the database software application; and for each of the phases of development that requires a change in a schema of the database, performing phase-wise migration of the database by sequentially modifying the schema of the database based on the changes in the schema of the database required by each phase.

In one aspect of the present invention, for each phase-wise migration, the schema is modified by data definition language statements defining modifications to a structure of the database and by data manipulation language statements specifying modification to data in the database.

In one aspect of the present invention, the method further comprises upgrading an installation of a database software application to a new phase, before performing phase-wise migration of the database.

In one aspect of the present invention, the method further comprises, before performing phase-wise migration of the database, performing at least one of upgrading a database management system that is used to manage the database used by the database software application, adjusting a size and structure of the database, and repopulating a metamodel of the database.

In one aspect of the present invention, the method further comprises, after performing phase-wise migration of the database, performing at least one of staring execution of the new phase of the database software application, performing database resynchronization involving recreating procedures, validating schema objects, or massaging metamodel to CM tables for syntactic cleanup, running migration scripts that require the database software application to be running, defragmenting the database, and checking consistency of the database.

### BRIEF DESCRIPTION OF THE DRAWINGS

FIG. 1 is an exemplary diagram of a system in which the present invention may be implemented.

FIG. 2 is an exemplary flow diagram of a process of phased migration, according to the present invention.

FIG. 3 is an exemplary flow diagram of a step of a process of phased migration, according to the present invention.

FIG. 4 is an exemplary flow diagram of a step of a process of phased migration, according to the present invention.

FIG. 5 is an exemplary flow diagram of a step of a process of phased migration, according to the present invention.

FIG. 6 is an exemplary flow diagram of a step of a process of phased migration, according to the present invention.

FIG. 7 is an exemplary flow diagram of a step of a process of phased migration, according to the present invention.

FIG. 8 is an exemplary flow diagram of a process of phased migration, according to the present invention.

FIG. 9 is an exemplary block diagram of a computer system, in which the present invention may be implemented.

### DETAILED DESCRIPTION OF THE PREFERRED EMBODIMENTS

The present invention provides in-place, phased migration from one version of a database software application release version to another of a software release version. Using the present invention, a software release can be upgraded without recreating any associated database. The present invention provides improved migration performance, particularly when moderate schema changes occur in the new release. In addition, the present invention builds migration scripts while the new releases of the software application are being developed and provides migration from one development phase to another development phase in the same release. Phased migration provides improved system testing ability, particularly to test migrated platforms. Data migration issues are caught early in the development cycle, rather than at customer sites. Phased migration also reduces effort to re-install and recover the database for each development phase.

The present invention is applicable to any database software application in which a new software version is developed in phases. As each phase version is released, the new phase version of the software application is installed in place of the previous software version, which may be a prior release of the software, or which may be a previous phase version of the software. The database used by the software application, however, is not uninstalled. Instead, the existing database is migrated to be compatible with the newly installed phase version of the software by modifying the schema of the database accordingly. The phase migrations may be performed sequentially to migrate the database from any software version or phase version to any later version or phase version.

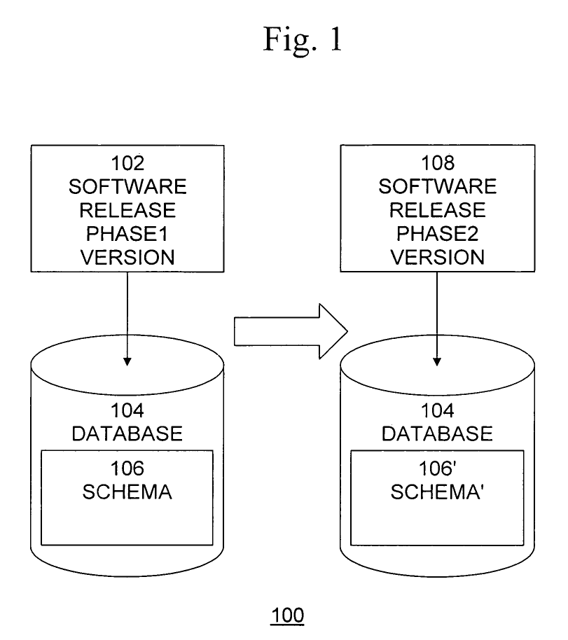

An example of a system 100, in which the present invention may be implemented, is shown in FIG. 1. In system 100, a software application of a particular release version, such as software release 1 102, performs functions in conjunction with a database 104. Database 104 includes a collection of information organized in such a way that computer software can select and retrieve desired pieces of data. Traditional databases are organized by fields, records, and files. A field is a single piece of information; a record is one complete set of fields; and a file is a collection of records. An alternative concept in database design is known as Hypertext. In a Hypertext database, any object, whether it be a piece of text, a picture, or a film, can be linked to any other object. Hypertext databases are particularly useful for organizing large amounts of disparate information, but they are not designed for numerical analysis.

Database management functions perform accesses to the database and store or retrieve data from the database. Such functions are often termed queries and are performed by using a database query language, such as structured query language (SQL). SQL is a standardized query language for requesting information from a database. Historically, SQL has been a popular query language for database management systems running on minicomputers and mainframes. Increasingly, however, SQL is being supported by personal computer database systems because it supports distributed databases (databases that are spread out over several computer systems). This enables several users on a local-area network to access the same database simultaneously.

Most full-scale database systems are relational database systems. Small database systems, however, use other designs that provide less flexibility in posing queries. Relational databases are powerful because they require few assumptions about how data is related or how it will be extracted from the database. As a result, the same database can be viewed in many different ways. An important feature of relational systems is that a single database can be spread across several tables. This differs from flat-file databases, in which each database is self-contained in a single table.

Database 104 includes schema 106, which is a definition of the structure and contents of the database, such as names and definitions of database tables, columns in those tables, relationships among the tables, etc.

When a new development phase version of a software application that uses a database is released, such as software release 2 108, that new phase version is installed and may begin using database 104. However, typically, the changes that are made to a new phase version of software require the database to have data defined using a different schema than the schema that was used by the previous phase version of the software. For example, new software release phase2 version 108 requires the use of data in database 104 that is defined by schema 106′, while the previous software release phase1 version 102 requires the use of data in database 104 that is defined by schema 106.

The present invention performs phased migration of data in the database to conform to the new schema for a new release version of software. Phased Migration includes:
Determining the current database software phase version.
Determining the current published build label.
Incrementally migrating the database till the current build label.

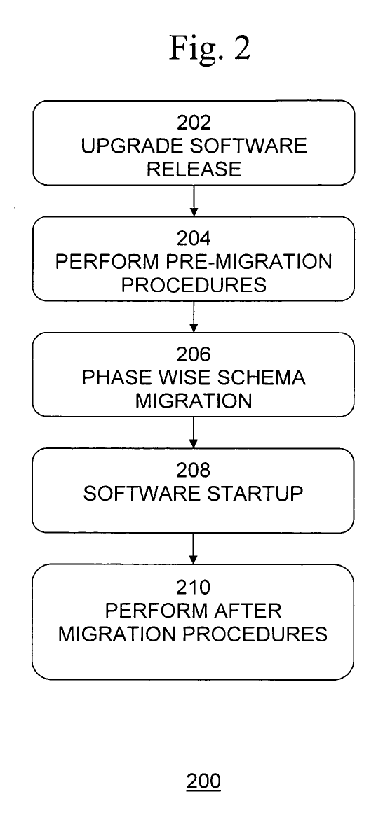

An example of a process 200 of phased migration is shown in FIG. 2. Process 200 begins with step 202, in which the installed software application is upgraded to a new release of the software application. In step 204, pre-migration procedures are performed to the database. In step 206, phase-wise migration of the schema of the database is performed. There may be multiple phase-wise migrations performed in this step, if the software version being installed is multiple phase versions newer than the currently installed software. In step 208, the newly installed software release is started up. In step 210, any needed after migration procedures are performed.

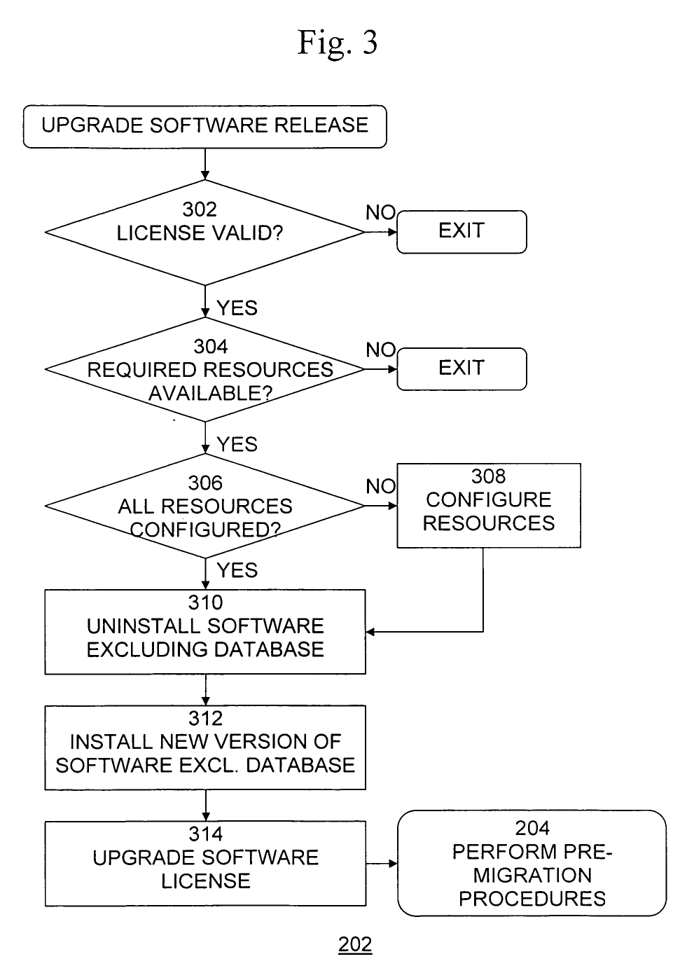

An example of a step 202 of a process of phased migration is shown in FIG. 3. Step 202 involves upgrading an installed software application to a new phase version of the software is shown. The process of step 202 begins with step 302, in which it is determined whether the license for the software upgrade is valid. If the license is not valid, then the process exits. If the license is valid, then the process continues with step 304, in which it is determined whether the required resources for the software upgrade are available. If the required resources are not available, then the process exits. If the required resources are available, the process continues with step 306, in which it is determined whether all required resources are properly configured. If any resources are not properly configured, the process continues with step 308, in which the resources that need configuration are configures. Once all required resources are configures, whether from step 306 or 308, the process continues with step 310, in which the currently installed software version (whether a previous release or a previous phase version) is uninstalled. The database, however, is not uninstalled. In step 312, the new software release version is installed. Again, the database is not affected. The process then continues with step 204.

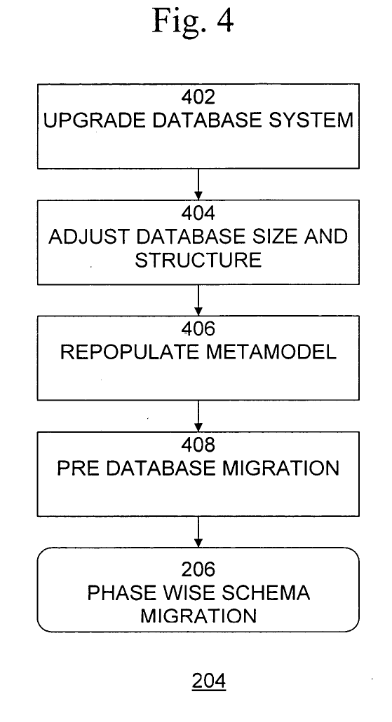

An example of a step 204 of a process of phased migration is shown in FIG. 4. Step 204 involves performing pre-migration procedures to the database. In step 402, the database management system that is used to manage the database used by the software application is upgraded, if necessary. In step 404, the size and structure of the database is adjusted, if necessary. In step 406, the metamodel of the database is repopulated. In step 408, pre-database migration operations, such as modifying control files, etc., are performed. The process then continues with step 206.

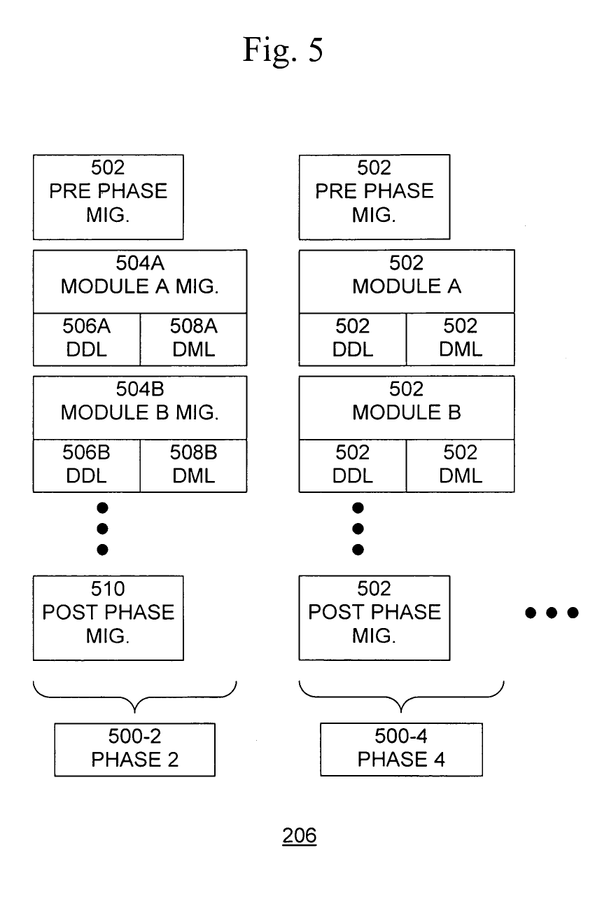

An example of a step 206 of a process of phased migration is shown in FIG. 5. Step 206 involves phase-wise migration of the schema of the database. Phase-wise migration proceeds according to each phase of development of a software release. For example, in the example shown in FIG. 5, migration is performed in phase 2 500-2 and phase 4 500-4, as well as other phases (not shown). In each phase, pre-phase migration operations 502 are performed, such as database adjustment required for the phase migration, permission changes to some specific objects, creating/renaming tablespaces, etc. Then, the phased migration is performed by modules, such as module A 504A, module B 504B, etc. Each module typically includes a data definition language (DDL) portion, such as DDL 506A, and a data manipulation language (DML) portion, such as DML 508A. A DDL is a computer language for defining data. For example, a DDL schema is commonly used to define the structure of data in a database. A subset of instructions in SQL form a commonly used DDL. A DML is a family of computer languages used by computer programs or database users to retrieve, insert, delete, and update data in a database. A common example of such a DML is SQL. The DDL and DML in each module make changes to the database so that the database conforms to the phase of the software release. Post phase migration operations 510, such as recompiling procedures, giving permissions, cleaning up resources used by migration scripts, etc., are performed after the phased migration is performed.

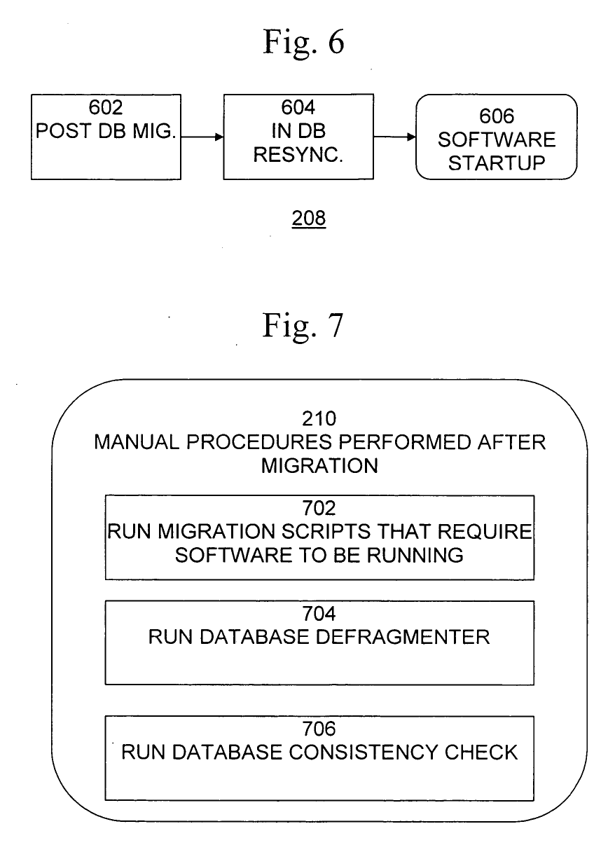

An example of a step 208 of a process of phased migration is shown in FIG. 6. Step 208 involves start up of the newly installed software release. In step 602, post database migration processing is performed. In step 604, in database resynchronization involving recreating procedures, validating schema objects, massaging database tables for syntactic cleanup, etc. In step 606, the newly installed software release is started up to begin operation with the migrated database.

An example of a step 210 of a process of phased migration is shown in FIG. 7. Step 210 involves performing any steps needed after migration procedures. For example, in step 702, migration scripts that require the software application to be running are performed. In step 704, the database defragmenter is run. In step 706, a check of the database consistency is performed.

Preferably, phased migration is achieved through a framework that is developed by database administrators to allow incremental schema changes to a developer's database. Typically, template scripts are provided for developers to write their own migration scripts. The schema modifications may then be consolidated.

Phased migration provides advantages, such as:
System test does not require dismantling of earlier data sets.
Development team develops and tests their part of the schema changes as part of their development and unit test.
A customer support team can migrate a customer database to the current development phase and for software release to a customer before the final product release. Such software release is qualified as beta software or pre general availability software.
Saves time in system test/integration and development installations during phase loads (schema will be migrated rather than reinstalled).

Examples of simple schema changes in a development environment include:
Adding a new column.
Modifying columns: either column size or column type or both.
Adding new tables.

In some cases, a schema table may be changed more than once in a given release. If same table is changed repeatedly and it has performance issues, the affected scripts should be rewritten. These scripts will be kept in final release directory which directly goes from the first phase.

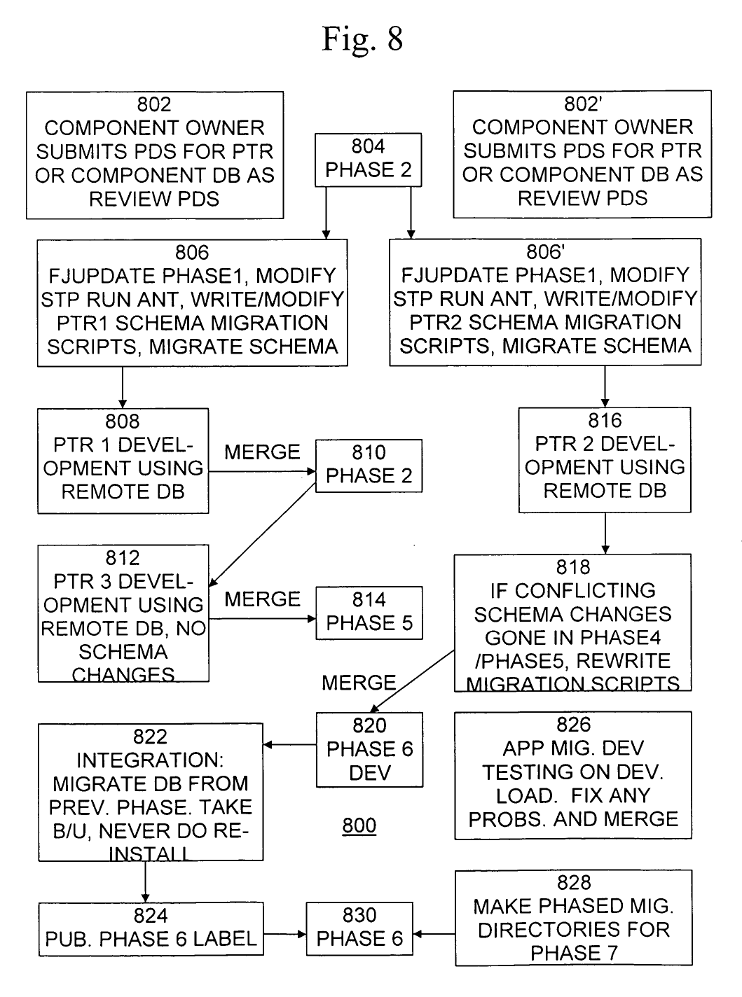

The present invention is applicable to any database software application in which a new software version is developed in phases. An example of such a database software application is a network management application, in which characteristics of multiple network elements, including the connection topology of the elements, is stored in a database. For example, the FUJITSU NETSMART 1500® network management application is such a software application. An example of a phased migration process 800 in the context of the NETSMART® application is shown in FIG. 8. In steps 802 and 802′, modifications to components of the software application and corresponding modifications to the database are accepted. In step 804, phase 2 of the software development process begins. In steps 806 and 806′, the modifications accepted in steps 802 and 802′ are implemented—component code is modified and database schema modification scripts are written/modified. Phase 2 schema migration is performed. In step 808, code development is performed on some components and in step 810, this is merged into the phase 2 version. In step 812, additional code development is performed on some components and in step 814, this is merged into the phase 5 version. Meanwhile, in step 816, code development is performed on other components. In step 818, if conflicting schema changes are gone in phase4 or phase 5, then schema migration scripts are rewritten. In step 820, these are merged into phase 6 development. In step 822, integration is performed by migrating the database from the previous phase and taking a backup. In step 824, the phase 6 label is published. In step 828, phased migration directories for phase 7 are created. In step 830, the phase 6 version is release.

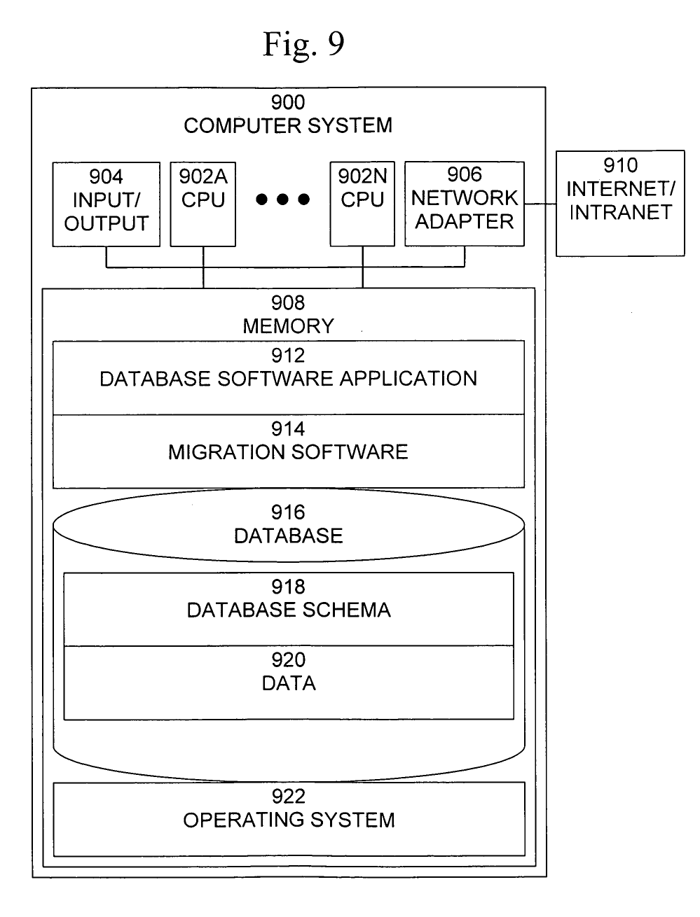

An exemplary block diagram of a computer system 900, in which the present invention may be implemented, is shown in FIG. 9. System 900 is typically a programmed general-purpose computer system, such as a personal computer, workstation, server system, and minicomputer or mainframe computer. System 900 includes one or more processors (CPUs) 902A-902N, input/output circuitry 904, network adapter 906, and memory 908. CPUs 902A-902N execute program instructions in order to carry out the functions of the present invention. Typically, CPUs 902A-902N are one or more microprocessors, such as an INTEL PENTIUM® processor. FIG. 9 illustrates an embodiment in which system 900 is implemented as a multiple-processor computer system, in which multiple processors 902A-902N share system resources, such as memory 908, input/output circuitry 904, and network adapter 906. However, the present invention also contemplates embodiments in which system 900 is implemented as a plurality of networked computer systems, which may be single-processor computer systems, multi-processor computer systems, or a mix thereof.

Input/output circuitry 904 provides the capability to input data to, or output data from, database/system 900. For example, input/output circuitry may include input devices, such as keyboards, mice, touchpads, trackballs, scanners, etc., output devices, such as video adapters, monitors, printers, etc., and input/output devices, such as, modems, etc. Network adapter 906 interfaces database/system 900 with Internet/intranet 910. Internet/intranet 910 may include one or more standard local area network (LAN) or wide area network (WAN), such as Ethernet, Token Ring, the Internet, or a private or proprietary LAN/WAN.

Memory 908 stores program instructions that are executed by, and data that are used and processed by, CPU 902 to perform the functions of system 900. Memory 908 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (ELDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 908 varies depending upon the function that system 900 is programmed to perform. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 9, memory 908 includes database software application 912, migration software 914, database 916, database schema 918, data 920, and operating system 922. Database software application is software that performs desired functions in conjunction with database 916. Database 916 includes database schema 918, which is a definition of the structure and contents of the database, such as names and definitions of database tables, columns in those tables, relationships among the tables, etc. Database 916 also includes data 920, which is the actual data contained in the database, including the database tables. Migration software 914 performs the phase-wise migration of the database, including modification of the database schema 918, as well as other pre-migration and post-migration procedures. Operating system 928 provides overall system functionality.

As shown in FIG. 9, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINIDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for phased migration of a database software application comprising:
developing a database software application in a plurality of phases of development, at least some of the plurality of phases of development requiring a change in a schema of a database used by the database software application; and
for each of the phases of development that requires a change in a schema of the database, performing phase-wise migration of the database by sequentially modifying the schema of the database based on the changes in the schema of the database required by each phase.

2. The method of claim 1, wherein, for each phase-wise migration, the schema is modified by data definition language statements defining modifications to a structure of the database and by data manipulation language statements specifying modification to data in the database.

3. The method of claim 1, further comprising:
before performing phase-wise migration of the database, upgrading an installation of a database software application to a new phase.

4. The method of claim 3, further comprising:
before performing phase-wise migration of the database, performing at least one of:
upgrading a database management system that is used to manage the database used by the database software application;
adjusting a size and structure of the database; and
repopulating a metamodel of the database.

5. The method of claim 4, further comprising:
after performing phase-wise migration of the database, performing at least one of:
staring execution of the new phase of the database software application;
performing database resynchronization involving recreating procedures, validating schema objects, or massaging metamodel to CM tables for syntactic cleanup;
running migration scripts that require the database software application to be running;
defragmenting the database; and
checking consistency of the database.

6. A computer program product for performing phased migration of a database software application developed in a plurality of phases of development, at least some of the plurality of phases of development requiring a change in a schema of a database used by the database software application, comprising:
a computer readable medium;
computer program instructions, recorded on the computer readable medium, executable by a processor, for performing the steps of
for each of the phases of development that requires a change in a schema of the database, performing phase-wise migration of the database by sequentially modifying the schema of the database based on the changes in the schema of the database required by each phase.

7. The computer program product of claim 6, wherein, for each phase-wise migration, the schema is modified by data definition language statements defining modifications to a structure of the database and by data manipulation language statements specifying modification to data in the database.

8. The computer program product of claim 6, further comprising:
before performing phase-wise migration of the database, upgrading an installation of a database software application to a new phase.

9. The computer program product of claim 8, further comprising:
before performing phase-wise migration of the database, performing at least one of:
upgrading a database management system that is used to manage the database used by the database software application;
adjusting a size and structure of the database; and
repopulating a metamodel of the database.

10. The computer program product of claim 9, further comprising:
after performing phase-wise migration of the database, performing at least one of:
staring execution of the new phase of the database software application;
performing database resynchronization involving recreating procedures, validating schema objects, or massaging metamodel to CM tables for syntactic cleanup;
running migration scripts that require the database software application to be running;
defragmenting the database; and
checking consistency of the database.

11. A system operable to perform phased migration of a database software application developed in a plurality of phases of development, at least some of the plurality of phases of development requiring a change in a schema of a database used by the database software application, comprising:
a processor operable to execute computer program instructions;
a memory operable to store computer program instructions executable by the processor; and
computer program instructions stored in the memory and executable to perform the steps of:
for each of the phases of development that requires a change in a schema of the database, performing phase-wise migration of the database by sequentially modifying the schema of the database based on the changes in the schema of the database required by each phase.

12. The system of claim 11, wherein, for each phase-wise migration, the schema is modified by data definition language statements defining modifications to a structure of the database and by data manipulation language statements specifying modification to data in the database.

13. The system of claim 11, further comprising:
before performing phase-wise migration of the database, upgrading an installation of a database software application to a new phase.

14. The system of claim 13, further comprising:
before performing phase-wise migration of the database, performing at least one of:
upgrading a database management system that is used to manage the database used by the database software application;
adjusting a size and structure of the database; and
repopulating a metamodel of the database.

15. The system of claim 14, further comprising:
after performing phase-wise migration of the database, performing at least one of:
staring execution of the new phase of the database software application;
performing database resynchronization involving recreating procedures, validating schema objects, or massaging metamodel to CM tables for syntactic cleanup;
running migration scripts that require the database software application to be running;
defragmenting the database; and
checking consistency of the database.
